(19) United States
(12) Patent Application Publication
(10) Pub. No.: US 2023/0297670 A1
(43) Pub. Date: Sep. 21, 2023

(54) SYSTEMS AND METHODS FOR MANAGING REPUTATION SCORES ASSOCIATED WITH DETECTION OF MALICIOUS VEHICLE TO VEHICLE MESSAGES

(71) Applicant: GM Global Technology Operations LLC, Detroit, MI (US)

(72) Inventor: Wenyuan Qi, Shanghai (CN)

(21) Appl. No.: 17/706,031

(22) Filed: Mar. 28, 2022

(30) Foreign Application Priority Data
Mar. 21, 2022 (CN) 2022102779908

(51) Int. Cl. G06F 21/55

(52) U.S. Cl. CPC G06F 21/554

(57) ABSTRACT

At least two vehicle behavior reports are received at a reputation score management system. Each of the vehicle behavior reports is received from a corresponding traffic autonomous vehicle and includes a unique vehicle identifier and a classification result associated with a source autonomous vehicle. A reputation score is generated for association with the unique vehicle identifier based at least in part on the classification results received in the at least two vehicle behavior reports. A request for the reputation score associated with the unique vehicle identifier is received from an ego autonomous vehicle. The requested reputation score is transmitted to the ego autonomous vehicle to enable the ego autonomous vehicle to determine whether a V2V message including the unique vehicle identifier associated with the requested reputation score is one of an honest V2V message and a malicious V2V message based in part on the reputation score.

### INTRODUCTION

The technical field generally relates to autonomous vehicles, and more particularly relates to systems and methods for managing reputation scores associate with detection of malicious vehicle-to-vehicle (V2V) messages.

Autonomous vehicles are typically configured to receive vehicle-to-vehicle (V2V) messages from other autonomous vehicles. An example of a V2V messages is a Basic Safety Message (BSM). A V2V message includes a vehicle identifier and vehicle data associated with the transmitting vehicle. Automated driving systems (ADS) of autonomous vehicles often rely on the vehicle data contained in V2V messages received from other autonomous vehicles to properly guide and navigate the autonomous vehicle.

The ADS at an autonomous vehicle may rely on malicious vehicle data in received malicious V2V messages to implement one or more actions that could potentially lead to degradation in traffic related guidance efficiencies or implementation of maneuvers to avoid non-existent ghost vehicles that may lead to potential accidents.

### SUMMARY

In an embodiment, a reputation score management system at an edge computing system includes a processor and a memory. The memory includes instructions that upon execution by the processor, cause the processor to: receive at least two vehicle behavior reports associated with a source autonomous vehicle, each of the at least two vehicle behavior reports being received from a corresponding one of at least two traffic autonomous vehicles and comprising a unique vehicle identifier and a classification result associated with the source autonomous vehicle; generate a reputation score for association with the unique vehicle identifier based at least in part on the classification results received in the at least two vehicle behavior reports; receive a request for the reputation score associated with the unique vehicle identifier from an ego autonomous vehicle; and transmit the requested reputation score to the ego autonomous vehicle to enable the ego autonomous vehicle to determine whether a vehicle-to-vehicle (V2V) message including the unique vehicle identifier associated with the requested reputation score is one of an honest V2V message and a malicious V2V message based in part on the reputation score.

In an embodiment, the memory further includes instructions that upon execution by the processor, cause the processor to generate the reputation score based on an application of a classification result algorithm to the classification results received in the at least two vehicle behavior reports.

In an embodiment, a first vehicle behavior report includes a first detection result in connection with a first malicious behavior type associated with a first weight and a second vehicle behavior report includes a second detection result in connection with a second malicious behavior type associated with a second weight and the memory further includes instructions that upon execution by the processor, cause the processor to generate the reputation score based on an application of a weighted malicious behavior algorithm to the first detection result in accordance with the first weight and the second detection result in accordance with the second weight.

In an embodiment, the at least two vehicle behavior reports in aggregate includes a first combination of different forms of a first malicious behavior type and a second combination of different forms of a second malicious behavior type and the memory further includes instructions that upon execution by the processor, cause the processor to generate the reputation score based on an application of a Dempster-Shafer algorithm to the first combination of different forms of the first malicious behavior type and the second combination of different forms of a second malicious behavior type and a belief function value associated with each of the at least two traffic autonomous vehicles.

In an embodiment, the memory further includes instructions that upon execution by the processor, cause the processor to generate the reputation score based on an application of a machine learning algorithm to a plurality of probabilities associated with the source autonomous vehicle and a probability of generation of a reputation score classifying the source autonomous vehicle as a malicious vehicle, each of the plurality of probabilities being associated with a probability that the source autonomous vehicle will engage in a misbehavior type.

In an embodiment, the memory further includes instructions that upon execution by the processor, cause the processor to: generate a unique report identifier for each of the at least two vehicle behavior reports received from the corresponding one of the at least two traffic autonomous vehicles, each of the at least two traffic autonomous vehicles being classified as an honest vehicle based on an association with a block chain; and record the classification results received in each of the at least two vehicle behavior reports at the block chain.

In an embodiment, the memory further includes instructions that upon execution by the processor, cause the processor to receive a vehicle behavior report from the ego autonomous vehicle, the vehicle behavior report including a classification result classifying the source autonomous vehicle as one of a honest vehicle and a malicious vehicle based in part on the reputation score associated with the source autonomous vehicle.

In an embodiment, a computer readable medium including instructions stored thereon for managing reputation scores, that upon execution by a processor, cause the processor to: receive at least two vehicle behavior reports associated with a source autonomous vehicle, each of the at least two vehicle behavior reports being received from a corresponding one of at least two traffic autonomous vehicles and comprising a unique vehicle identifier and a classification result associated with the source autonomous vehicle; generate a reputation score for association with the unique vehicle identifier based at least in part on the classification results received in the at least two vehicle behavior reports; receive a request for the reputation score associated with the unique vehicle identifier from an ego autonomous vehicle; and transmit the requested reputation score to the ego autonomous vehicle to enable the ego autonomous vehicle to determine whether a vehicle-to-vehicle (V2V) message including the unique vehicle identifier associated with the requested reputation score is one of an honest V2V message and a malicious V2V message based in part on the reputation score.

In an embodiment, the computer readable medium further includes instructions to cause the processor to generate the reputation score based on an application of a classification result algorithm to the classification results received in the at least two vehicle behavior reports.

In an embodiment, the computer readable medium further includes instructions to cause the processor to generate the reputation score based on an application of a weighted malicious behavior algorithm to a first detection result in accordance with a first weight and a second detection result in accordance with a second weight, wherein a first vehicle behavior report includes the first detection result in connection with a first malicious behavior type associated with the first weight and a second vehicle behavior report includes the second detection result in connection with a second malicious behavior type associated with the second weight .

In an embodiment, the computer readable medium further includes instructions to cause the processor to generate the reputation score based on an application of a Dempster-Shafer algorithm to a first combination of different forms of a first malicious behavior type and a second combination of different forms of a second malicious behavior type and a belief function value associated with each of the at least two traffic autonomous vehicles, wherein the at least two vehicle behavior reports in aggregate comprises the first combination of different forms of the first malicious behavior type and the second combination of different forms of the second malicious behavior type.

In an embodiment, the computer readable medium further includes instructions to cause the processor to generate the reputation score based on an application of a machine learning algorithm to a plurality of probabilities associated with the source autonomous vehicle and a probability of generation of a reputation score classifying the source autonomous vehicle as a malicious vehicle, each of the plurality of probabilities being associated with a probability that the source autonomous vehicle will engage in a misbehavior type.

In an embodiment, the computer readable medium further includes instructions to cause the processor to: generate a unique report identifier for each of the at least two vehicle behavior reports received from the corresponding one of the at least two traffic autonomous vehicles, each of the at least two traffic autonomous vehicles being classified as an honest vehicle based on an association with a block chain; and record the classification results received in each of the at least two vehicle behavior reports at the block chain.

In an embodiment, the computer readable medium further includes instructions to cause the processor to receive a vehicle behavior report from the ego autonomous vehicle, the vehicle behavior report including a classification result classifying the source autonomous vehicle as one of a honest vehicle and a malicious vehicle based in part on the reputation score associated with the source autonomous vehicle.

In an embodiment, a method of managing reputation scores includes receiving at least two vehicle behavior reports associated with a source autonomous vehicle at a reputation score management system, each of the at least two vehicle behavior reports being received from a corresponding one of at least two traffic autonomous vehicles and comprising a unique vehicle identifier and a classification result associated with the source autonomous vehicle; generating a reputation score for association with the unique vehicle identifier based at least in part on the classification results received in the at least two vehicle behavior reports at the reputation score management system; receiving a request for the reputation score associated with the unique vehicle identifier from an ego autonomous vehicle at the reputation score management system; and transmitting the requested reputation score from at the reputation score management system to the ego autonomous vehicle to enable the ego autonomous vehicle to determine whether a vehicle-to-vehicle (V2V) message including the unique vehicle identifier associated with the requested reputation score is one of an honest V2V message and a malicious V2V message based in part on the reputation score.

In an embodiment, the method further includes generating the reputation score based on an application of a classification result algorithm to the classification results received in the at least two vehicle behavior reports at the reputation score management system.

In an embodiment, the method further includes generating the reputation score based on an application of a weighted malicious behavior algorithm to a first detection result in accordance with a first weight and a second detection result in accordance with a second weight at the reputation score management system, wherein a first vehicle behavior report includes the first detection result in connection with a first malicious behavior type associated with the first weight and a second vehicle behavior report includes the second detection result in connection with a second malicious behavior type associated with the second weight.

In an embodiment, the method further includes generating the reputation score based on an application of a Dempster-Shafer algorithm to a first combination of different forms of a first malicious behavior type and a second combination of different forms of a second malicious behavior type and a belief function value associated with each of the at least two traffic autonomous vehicles at the reputation score management system, wherein the at least two vehicle behavior reports in aggregate comprises the first combination of different forms of the first malicious behavior type and the second combination of different forms of the second malicious behavior type.

In an embodiment, the method further includes generating the reputation score based on an application of a machine learning algorithm to a plurality of probabilities associated with the source autonomous vehicle and a probability of generation of a reputation score classifying the source autonomous vehicle as a malicious vehicle at the reputation score management system, each of the plurality of probabilities being associated with a probability that the source autonomous vehicle will engage in a misbehavior type.

In an embodiment, the method further includes generating a unique report identifier for each of the at least two vehicle behavior reports received from the corresponding one of the at least two traffic autonomous vehicles, each of the at least two traffic autonomous vehicles being classified as an honest vehicle based on an association with a block chain; and recording the classification results received in each of the at least two vehicle behavior reports at the block chain.

### BRIEF DESCRIPTION OF THE DRAWINGS

Exemplary embodiments will hereinafter be described in conjunction with the following drawing figures, wherein like numerals denote like elements.

FIG. 1 is a functional block diagram representation of an autonomous vehicle communicatively coupled to an edge computing system including an embodiment of a reputation score management system;

FIG. 2 is a functional block diagram representation of an edge computing system including an embodiment of a reputation score management system;

FIG. 3 is a flow chart representation of an embodiment of a method of managing a reputation score associated with a vehicle identifier using an embodiment of the reputation score management system;

FIG. 4 is a flow chart representation of an embodiment of a method of detecting a malicious vehicle-to-vehicle message at an ego autonomous vehicle based on a reputation score received from an embodiment of the reputation score management system; and

FIG. 5 is a flow chart representation of an embodiment of a method of managing a reputation score associated with a vehicle identifier at an embodiment of a reputation score management system.

### DETAILED DESCRIPTION

The following detailed description is merely exemplary in nature and is not intended to limit the application and uses. Furthermore, there is no intention to be bound by any expressed or implied theory presented in the preceding introduction, summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

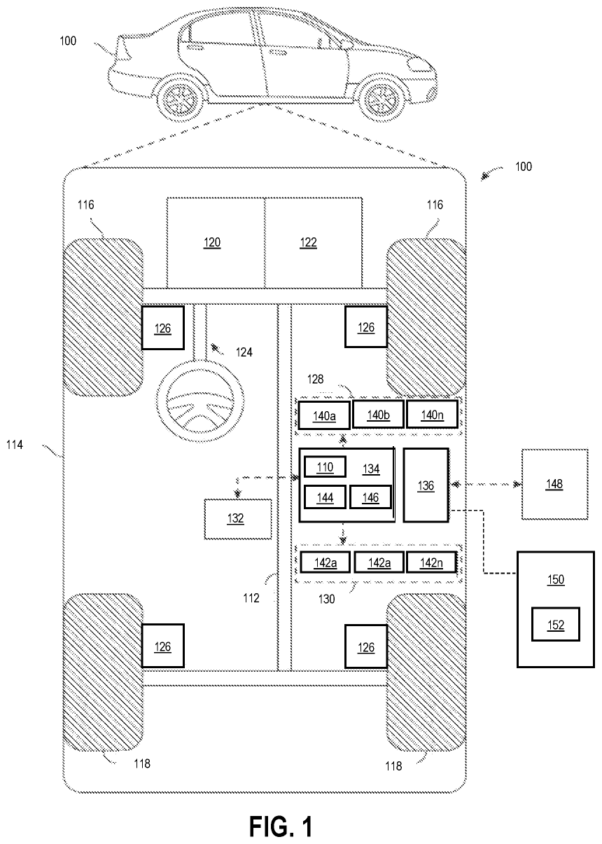

Referring to FIG. 1 a functional block diagram representation of an autonomous vehicle 100 communicatively coupled to an edge computing system 150 including an embodiment of a reputation score management system 152 is shown. In an embodiment, the edge computing system 150 is configured to host a local authority that includes an embodiment of the reputation score management system 152. The reputation score management system 152 is configured to maintain reputations scores associated with different vehicle identifiers based on vehicle behavior reports received in connection with the vehicle identifiers from traffic autonomous vehicles. Each of the traffic autonomous vehicles have a configuration similar to the configuration of the autonomous vehicle 100 described with reference to FIG. 1. An ego autonomous vehicle includes a misbehavior detection system 110. The ego autonomous vehicle has a configuration similar to the configuration of the autonomous vehicle 100 described with reference to FIG. 1. Each of the plurality of traffic autonomous vehicles is configured to operate as an ego autonomous vehicle and the ego autonomous vehicle is configured to operate as a traffic autonomous vehicle.

The misbehavior detection system 110 is configured to transmit vehicle behavior reports associated with a vehicle identifier in a received vehicle-to-vehicle (V2V) message to the reputation score management system 152. The misbehavior detection system 110 is configured to receive a reputation score associated with a vehicle identifier in a received V2V message from the reputation score management system 152 and determine whether the V2V message is a malicious V2V message based at least in part on the reputation score. In an embodiment, the V2V message is a Basic Safety Message (BSM).

The autonomous vehicle 100 generally includes a chassis 112, a body 114, front wheels 116, and rear wheels 118. The body 114 is arranged on the chassis 112 and substantially encloses components of the autonomous vehicle 100. The body 114 and the chassis 112 may jointly form a frame. The front wheels 116 and the rear wheels 118 are each rotationally coupled to the chassis 112 near a respective corner of the body 114.

The autonomous vehicle 100 is, for example, a vehicle that is automatically controlled to carry passengers from one location to another. While the autonomous vehicle 100 is depicted in the illustrated embodiment as a passenger car, other examples of autonomous vehicles include, but are not limited to, motorcycles, trucks, sport utility vehicles (SUVs), recreational vehicles (RVs), marine vessels, and aircraft. In an embodiment, the autonomous vehicle 100 is a so-called Level Four or Level Five automation system. A Level Four system indicates “high automation”, referring to the driving mode-specific performance by an automated driving system (ADS) of all aspects of the dynamic driving task, even if a human driver does not respond appropriately to a request to intervene. A Level Five system indicates “full automation”, referring to the full-time performance by an ADS of all aspects of the dynamic driving task under all roadway and environmental conditions that can be managed by a human driver.

As shown, the autonomous vehicle 100 generally includes a propulsion system 120, a transmission system 122, a steering system 124, a brake system 126, a vehicle sensor system 128, an actuator system 130, at least one data storage device 132, at least one controller 134, and a vehicle communication system 136. The propulsion system 120 may, in various embodiments, include an internal combustion engine, an electric machine such as a traction motor, and/or a fuel cell propulsion system. The transmission system 122 is configured to transmit power from the propulsion system 120 to the front wheels 116 and the rear wheels 118 according to selectable speed ratios. According to various embodiments, the transmission system 122 may include a step-ratio automatic transmission, a continuously-variable transmission, or other appropriate transmission. The brake system 126 is configured to provide braking torque to the front wheels 116 and the rear wheels 118. The brake system 126 may, in various embodiments, include friction brakes, brake by wire, a regenerative braking system such as an electric machine, and/or other appropriate braking systems. The steering system 124 influences a position of the front wheels 116 and the rear wheels 118. While depicted as including a steering wheel for illustrative purposes, in some embodiments contemplated within the scope of the present disclosure, the steering system 124 may not include a steering wheel.

The vehicle sensor system 128 includes one or more vehicle sensing devices 140a-140n that sense observable conditions of the exterior environment and/or the interior environment of the autonomous vehicle 100. Examples of vehicle sensing devices 140a-140n include, but are not limited to, radars, lidars, global positioning systems, optical cameras, thermal cameras, ultrasonic sensors, and/or other sensors. The actuator system 130 includes one or more actuator devices 142a-142n that control one or more vehicle features such as for example, but not limited to, the propulsion system 120, the transmission system 122, the steering system 124, and the brake system 126. In various embodiments, the vehicle features can further include interior and/or exterior vehicle features such as for example, but are not limited to, doors, a trunk, and cabin features such as for example air, music, and lighting.

The vehicle communication system 136 is configured to wirelessly communicate information to and from other entities 148 (“vehicle-to-everything (V2X) communication), such as for example, but not limited to, other vehicles (“V2V” communication,) infrastructure (“vehicle-to-infrastructure (V2I)” communication), remote systems, and/or personal devices. The vehicle communication system 136 is configured to communicate information to and receive information from the edge computing system 150 including the embodiment of the reputation score management system 152. In an embodiment, the vehicle communication system 136 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels designed for automotive use and a corresponding set of protocols and standards.

The data storage device 132 stores data for use in automatically controlling the autonomous vehicle 100. The data storage device 132 may be part of the controller 134, separate from the controller 134, or part of the controller 134 and part of a separate system.

The controller 134 includes at least one processor 144 and a computer readable storage device 146. The computer readable storage device 146 may also be referred to a computer readable media 146 and a computer readable medium 146. In an embodiment, the computer readable storage device 146 includes the misbehavior behavior detection system 110. The processor 144 can be any custom made or commercially available processor, a central processing unit (CPU), a graphics processing unit (GPU), an auxiliary processor among several processors associated with the controller 134, a semiconductor-‘based microprocessor (in the form of a microchip or chip set), a macroprocessor, any combination thereof, or generally any device for executing instructions. The computer readable storage device 146 may include volatile and nonvolatile storage in read-only memory (ROM), random-access memory (RAM), and keep-alive memory (KAM), for example. KAM is a persistent or non-volatile memory that may be used to store various operating variables while the processor 144 is powered down. The computer-readable storage device 146 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 134 in controlling the autonomous vehicle 100.

The instructions may include one or more separate programs, each of which comprises an ordered listing of executable instructions for implementing logical functions. The instructions, when executed by the processor 144, receive and process signals from the vehicle sensor system 128, perform logic, calculations, methods and/or algorithms for automatically controlling the components of the autonomous vehicle 100, and generate control signals to the actuator system 130 to automatically control one or more components of the autonomous vehicle 100 based on the logic, calculations, methods, and/or algorithms. Although only one controller 134 is shown in FIG. 1, alternative embodiments of the autonomous vehicle 100 can include any number of controllers 134 that communicate over any suitable communication medium or a combination of communication mediums and that cooperate to process the sensor signals, perform logic, calculations, methods, and/or algorithms, and generate control signals to automatically control features of the autonomous vehicle 100.

In various embodiments, one or more instructions of the controller 134 are embodied to provide ADS functions as described with reference to one or more of the embodiments herein. The controller 134 or one of its functional modules is configured to implement the functions described with reference to received V2V messages based on reputation scores received from one or a combination of embodiments of the reputation score management system 152 at the edge computing system 150.

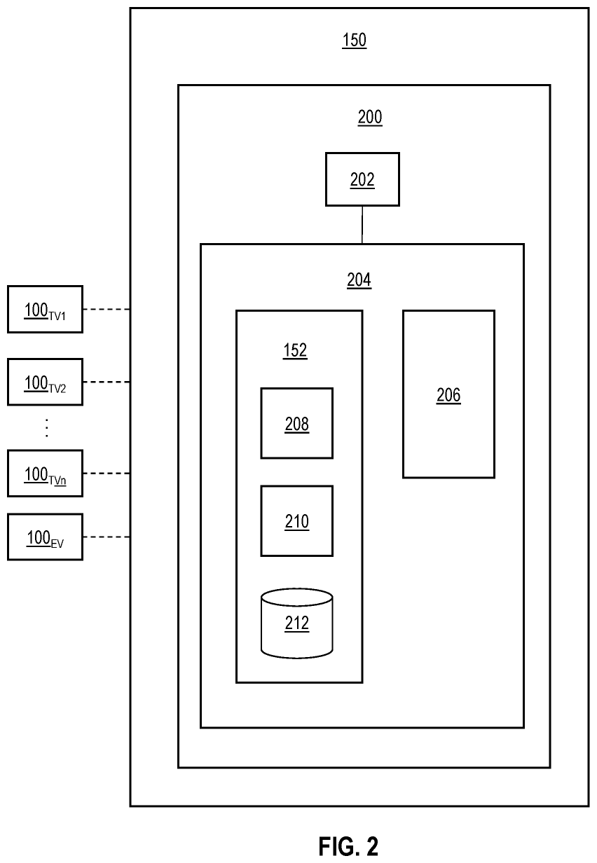

Referring to FIG. 2, a functional block diagram representation of an edge computing system 150 including an embodiment of reputation score management system 152 is shown. The edge computing system 150 is configured to be communicatively coupled to a plurality of traffic autonomous vehicles 100_{TV1}, 100_{TV2}, 100_{TVN} and an ego autonomous vehicle 100_{EV}. The plurality of traffic autonomous vehicles 100_{TV1}, 100_{TV2}, 100_{TVN} and the ego autonomous vehicle 100_{EV} have a configuration similar to the autonomous vehicle 100 described in FIG. 1. Each of the plurality of traffic autonomous vehicles 100_{TV1}, 100_{TV2}, 100_{TVN} is configured to operate as an ego autonomous vehicle 100_{EV} and the ego autonomous vehicle 100_{EV} is configured to operate as a traffic autonomous vehicle 100_{TV1}, 100_{TV2}, 100_{TVN}. Each of the plurality of traffic autonomous vehicles 100_{TV1}, 100_{TV2}, 100_{TVN} and the ego autonomous vehicle 100_{EV} include a misbehavior detection system 110.

The edge computing system 150 is configured to host a local authority 200. The local authority 200 may also be referred to as a security credentials management system (SCMS). The local authority 200 includes at least one processor 202 and a memory 204. In an embodiment, the memory 204 includes a certificate authority 206 and an embodiment of the reputation score management system 152. The local authority 200 may include additional components that facilitate operation of the local authority 200. The reputation score management system 152 includes a reputation score generation module 208, a reputation score request module 210, and a reputation score database 212. The reputation score management system 152 may include additional components that facilitate operation of the reputation score management system 152. While one configuration of the local authority 200 has been described, alternative embodiments of the local authority 200 may have different configurations.

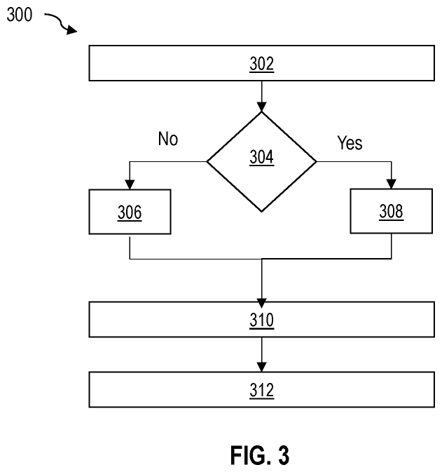

Referring to FIG. 3, a flow chart representation of an embodiment of a method 300 of generating a reputation score associated with a vehicle identifier using an embodiment of the reputation score management system 152 is shown. The method 300 may be performed by hardware circuitry, firmware, software, and/or combinations thereof.

At 302, a vehicle behavior report is received at the local authority 200 from a traffic autonomous vehicles 100_{TV1}, 100_{TV2}, 100_{TVN}. The traffic autonomous vehicles 100_{TV1}, 100_{TV2}, 100_{TVN} are configured to transmits vehicle behavior reports to the local authority 200. Each vehicle behavior report is associated with a V2V message received by a traffic autonomous vehicle 100_{TV1}, 100_{TV2}, 100_{TVN}. In an embodiment, the V2V message is a BSM message. The V2V message includes a unique vehicle identifier and source vehicle data. The unique vehicle identifier is associated with a source autonomous vehicle that may have transmitted the V2V message to the traffic autonomous vehicle 100_{TV1}, 100_{TV2}, 100_{TVN}. In an embodiment, the unique vehicle identifier is a pseudo identifier. The source vehicle data includes source vehicle attributes associated with the source autonomous vehicle. Examples of the source vehicle attributes include, but are not limited to, a source vehicle speed, a source vehicle location, a source vehicle acceleration, and a source vehicle heading.

The source autonomous vehicle may be an actual autonomous vehicle engaging in legitimate vehicle behavior, an actual autonomous vehicle engaging in malicious behavior, or a malicious entity posting as an actual autonomous vehicle. An actual autonomous vehicle engaging in legitimate vehicle behavior may be referred to as an honest vehicle. An actual autonomous vehicle engaging in malicious behavior, or a malicious entity posting as an actual autonomous vehicle may be referred to as a malicious vehicle.

Each vehicle behavior report includes the unique vehicle identifier and a classification result. In an embodiment, the unique vehicle identifier includes the pseudo identifier. In an embodiment, the vehicle behavior report includes a vehicle license plate of the source autonomous vehicle. In an embodiment, the vehicle behavior report includes at least one vehicle feature of the source autonomous vehicle. The classification result classifies the source autonomous vehicle as either an honest vehicle or a malicious vehicle. In an embodiment, the vehicle behavior report includes a malicious behavior type associated with a classification result of the source autonomous vehicle as a malicious vehicle. Examples of malicious behavior type include, but are not limited to, an improper source vehicle speed, an improper source vehicle location, and an improper vehicle acceleration. In an embodiment, the vehicle behavior report includes source vehicle features and/or historical source vehicle route data. In an embodiment, the vehicle behavior report includes the source vehicle data

At 304, the reputation score generation module 208 cooperates with the certificate authority 206 to determines whether a vehicle behavior record for a permanent vehicle identifier associated with the pseudo identifier received in the vehicle behavior report exists in the reputation score database 212. If the reputation score generation module 208 determines that a vehicle behavior record does not exist, the reputation score generation module 208 creates a vehicle behavior record associated with the permanent vehicle identifier and the pseudo identifier at 306. The method proceeds to 310. If the reputation score generation module 208 determines that a vehicle behavior record does exist, the reputation score generation module 208 cooperates with the certificate authority 206 to update the vehicle behavior record to associate the pseudo identifier with the permanent vehicle identifier at 308. The method proceeds to 310.

At 310, the reputation score generation module 208 calculates a reputation score based on a history of vehicle behavior reports received in connection with the permanent vehicle identifier associated with the pseudo identifier in the received vehicle behavior report. In an embodiment, the reputation score generation module 208 is configured to calculate the reputation score using a classification result algorithm. The reputation score generation module 208 generates the reputation score based on classification results associated with the permanent vehicle identifier that have been received by the reputation score generation module 208 from one or more traffic autonomous vehicles 100_{TV1}, 100_{TV2}, 100_{TVN} during a pre-defined time interval using the Equation 1 below.

Reputation Score=1/Σᵢ^{t}MCi(ifΣᵢ^{t}MCi0,S=1)

The variable t represents the number of vehicle behavior reports that have been received by the reputation score management module 308 in connection with the permanent vehicle identifier from one or more traffic autonomous vehicles 100_{TV1}, 100_{TV2}, 100_{TVN} during the pre-defined time interval. An example of a pre-defined time interval is 10 minutes. The variable MCᵢ represents the classification result of the i-th vehicle behavior report. The value of MCᵢ is 0 if the classification result in the i-th vehicle behavior report indicates that the source autonomous vehicle is an honest vehicle. The value of MCᵢ is 1 if the classification result in the i-th vehicle behavior report indicates the source autonomous vehicle is a malicious vehicle.

For example, the variable t may have a value of 5 indicating that five vehicle behavior reports have been received in connection with a permanent vehicle identifier from one or more traffic autonomous vehicles 100_{TV1}, 100_{TV2}, 100_{TVN} during the pre-defined time interval. The classification results associated with each of the five vehicle reports may have the following values MC₁=0, MC₂=1, MC₃=1, MC₄=1, and MC₅=1. The reputation score calculated using Equation 1 is 0.25. A reputation score threshold may be 0.5. In this example, since the reputation score is less than the reputation threshold, the source autonomous vehicle is a malicious vehicle.

In another example, the variable t may have a value of 5 indicating that five vehicle behavior reports have been received in connection with a permanent vehicle identifier from one or more traffic autonomous vehicles 100_{TV1}, 100_{TV2}, 100_{TVN} during the pre-defined time interval. The classification results associated with each of the five vehicle reports may have the following values MC₁=0, MC₂=0, MC₃=0, MC₄=1, and MC₅=1. The reputation score calculated using Equation 1 is 0.5. A reputation score threshold may be 0.5. In this example, since the reputation score is equal to the reputation threshold, the source autonomous vehicle is a malicious vehicle.

In another example, the variable t may have a value of 5 indicating that five vehicle behavior reports have been received in connection with a permanent vehicle identifier from one or more traffic autonomous vehicles 100_{TV1}, 100_{TV2}, 100_{TVN} during the pre-defined time interval. The classification results associated with each of the five vehicle reports may have the following values MC₁=0, MC₂=0, MC₃=0, MC₄=0, and MC₅=0. The reputation score calculated using Equation 1 is 1.0. A reputation score threshold may be 0.5. In this example, since the reputation score is greater than the reputation threshold, the source autonomous vehicle is a honest vehicle.

In an embodiment, the reputation score generation module 208 is configured to calculate the reputation score using a weighted malicious behavior algorithm using Equation 2 below.

Reputation Score=1/Σᵢ^{t}Σⱼ^{N}wj*MBij(ifΣⱼ^{N}MBij=0,S=1) Equation 2

The variable t represents the number of vehicle behavior reports that have been received by the reputation score generation module 208 in connection with the permanent vehicle identifier from one or more traffic autonomous vehicles 100_{TV1}, 100_{TV2}, 100_{TVN} during the pre-defined time interval. The variable N represents the number of times that a malicious behavior type has been reported in the received vehicle behavior reports. The variable MBᵢⱼ represents the jth malicious behavior type received in the ith vehicle behavior report received within the pre-defined time interval. Examples of different malicious behavior types include, but are not limited to, an improper source vehicle location, an improper source vehicle speed, and an improper source vehicle acceleration. The variable wⱼ represents the weight associated with a specific malicious behavior type. The value of MBᵢⱼ for a malicious behavior type is 0 if the malicious behavior type has not been detected. The value of MBᵢⱼ for a malicious behavior type is 1 if the malicious behavior type has been detected. Source autonomous vehicles having a reputation score of less than one are classified as malicious vehicles and source vehicles having a reputation score that is equal to or greater than one are classified as honest vehicles

In an example, the variable t may have a value of 10 indicating that ten vehicle behavior reports have been received in connection with a permanent vehicle identifier from one or more traffic autonomous vehicles 100_{TV1}, 100_{TV2}, 100_{TVN} during the pre-defined time interval. The variable j in MBᵢⱼ represents the malicious behavior type. A first malicious behavior type received in the vehicle behavior reports may be a malicious behavior type associated with an improper source vehicle location where j has a value of 1. A second malicious behavior type received in the vehicle behavior reports may be a malicious behavior type associated with an improper source vehicle speed where j has a value of 2. A fifth malicious behavior type received in the vehicle behavior reports may be a malicious behavior type associated with an improper source vehicle acceleration where j has a value of 5.

The values of MBᵢⱼ associated with each of the different malicious behavior types in the example may be represented as follows: MB_{1,1}=1 indicating that the oldest detection result of the first malicious behavior type is malicious; MB_{1,2}=1 indicating that the oldest detection result of the second malicious behavior type is malicious; MB_{5,5}=0 indicating that the 5^{th} detection result of the fifth malicious behavior type is honest; and MB_{10.2}=0 indicating that the latest detection result of second malicious behavior type is honest.

The weights associated with each of the different malicious behavior types in the example may be as follows: w₁=0.1 indicating the weight associated with the first malicious behavior type 1; w₂=0.6 indicating the weight associated with the second malicious behavior type; and w₅=0.9 indicating the weight associated with the fifth malicious behavior type. Applying Equation 2 to this example, the reputation score is 1.43 and is calculated as follows: 1/[(0.1(1)+(0.6)(1)+0.8(0)+(0.9)(0)]=1.43 In this example, since the reputation score is greater than one, the source autonomous vehicle is classified as an honest vehicle.

In an embodiment, the reputation score generation module 208 is configured to calculate the reputation score via an application of a Dempster-Shafer algorithm in accordance with Equation Set 3 below. Calculating the reputation score via an application of a Dempster-Shafer algorithm may enable the reputation score generation module 208 to account for uncertainties associated with the traffic autonomous vehicles 100_{TV1}, 100_{TV2}, 100_{TVN} responsible for generating the vehicle behavior reports. When applying the Dempster-Shafer algorithm, a belief function and plausibility function is assigned to each vehicle behavior report and each form of each malicious behavior type in each vehicle behavior report to enable the reputation score generation module 208 to account for such uncertainties.

$$M = \frac{1}{1 - \sum m 1 ( A ) * m 2 ( B )} \sum m 1 ( A ) * m 2 ( B ) \qquad Equation Set 3$$

$$m = {\sum }_{j}^{N} bel ( subset A ) .$$

$$Reputation Score = 1 / M$$

The variable A represents a first malicious behavior type. For example, the variable A may represent an inappropriate source vehicle speed. The variable B represents a second malicious behavior type. For example, the variable B may represent an inappropriate source vehicle location. The subset A represents a combination of the different forms of first malicious behavior type received in the vehicle behavior reports. For example, the different forms of inappropriate source vehicle speed may include a lower than an acceptable source vehicle speed A1, higher than an acceptable source vehicle speed A2, an unexpected source vehicle speed A3, etc.

The variable j is the jth different traffic autonomous vehicle 100_{TV1}, 100_{TV2}, 100_{TVN} to send a vehicle behavior report associated with the source autonomous vehicle where the vehicle behavior report indicates whether the source autonomous vehicle is engaging a form of the first malicious behavior type or not engaging in a form of the first malicious behavior type. Bel(A) is a belief function value indicating whether the jth traffic autonomous vehicle 100_{TV1}, 100_{TV2}, 100_{TVN} is trusted or not trusted to report on the form of the first malicious behavior type. The belief function values may be based on historical data associated with the traffic autonomous vehicle 100_{TV1}, 100_{TV2}, 100_{TVN}.

In an example, a first malicious behavior type A may be an inappropriate vehicle speed and a first form of the first malicious behavior type A may be a lower than acceptable vehicle speed A1. A first belief function value associated with a first traffic autonomous vehicle 100_{TV1}, 100_{TV2}, 100_{TVN} in connection with reporting the first form of the first malicious behavior type A1 may be 0.6 indicating that the first traffic autonomous vehicle 100_{TV1}, 100_{TV2}, 100_{TVN} can be trusted to report the first form of the first malicious behavior type A1. A second belief function value associated with a second traffic autonomous vehicle 100_{TV1}, 100_{TV2}, 100_{TVN} in connection with reporting the first form of the first malicious behavior type A1 may be 0.1 indicating that the second traffic autonomous vehicle 100_{TV1}, 100_{TV2}, 100_{TVN} cannot be trusted to report the first form of the first malicious behavior type A1. A third belief function value associated with a third traffic autonomous vehicle 100_{TV1}, 100_{TV2}, 100_{TVN} in connection with reporting the first form of the first malicious behavior type A1 may be 0.1 indicating that the third traffic autonomous vehicle 100_{TV1}, 100_{TV2}, 100_{TVN} cannot be trusted to report the first form of the first malicious behavior type A1. The value of m1(subset A1) is 0.6+0.1+01=0.8.

A value of m1(subset A2) may be calculated in a similar manner to be 0.9, where A2 is a second form of the first malicious behavior type A based on the belief function values associated with the reporting traffic autonomous vehicle 100_{TV1}, 100_{TV2}, 100_{TVN}. The second form of the first malicious behavior type A2 may be a higher than acceptable source vehicle speed.

A value of m2(subset B1) may be calculated in a similar manner to be 0.2, where B1 is a first form of the second malicious behavior type B based on the belief function values associated with the reporting traffic autonomous vehicle 100_{TV1}, 100_{TV2}, 100_{TVN}. The second malicious behavior type B may be an inappropriate source vehicle location. The first form of the second malicious behavior type B1 may be an inappropriate source vehicle lane location. A value of m2(subset B2) may be calculated in a similar manner to be 0.3, where B2 is a second form of the second malicious behavior type B based on the belief function values associated with the reporting traffic autonomous vehicle 100_{TV1}, 100_{TV2}, 100_{TVN}. The second form of the second malicious behavior type B2 may be an inappropriate source vehicle location consistency.

The value of M can be calculated for this example as follows:

M=1/(1−(0.8*0.2+0.9*0.3))*(0.8*0.2+0.9*0.3)=0.75

The value of the reputation score associated with the source autonomous vehicle can be calculated for this example as follows:

Reputation Score=1 /M=1.325

In this example, since the reputation score is greater than one, the source autonomous vehicle is classified as an honest vehicle.

In an embodiment, the reputation score generation module 208 is configured to calculate the reputation score via an application of a machine learning algorithm in accordance with an application of Equation Set 4 below. The application of the machine learning algorithm involves the use of deep learning neural network models. The reputation score can be predicted based on the historical behavior associated with the source autonomous vehicle. The historical behavior is based on the source vehicle data associated with the source autonomous vehicle received in previous vehicle behavior reports.

Malicious Behavior Type Type S,Ps=Softmax(S|M)

Reputation Score=Πₛ(1−Ps) Equation Set 4

The variable M is based on whether the source autonomous vehicle has a classification result as a malicious vehicle or an honest vehicle, a malicious behavior type, source vehicle features, source vehicle control dynamics, and source vehicle history routes. In an embodiment, each previously received vehicle behavior report includes the source vehicle classification result as a malicious vehicle or an honest vehicle, a malicious behavior type, source vehicle features, source vehicle control dynamics and source vehicle history routes. Ps is the probability of a malicious level reputation score associated with a malicious behavior type S. The regression model for each autonomous vehicle predicts the probability of each malicious behavior type with the following value pair: (Malicious behavior type S, Ps=Softmax(S|M). Softmax calculates the probability of a reputation score that classifies a source autonomous vehicle as a malicious vehicle based on an optimized machine learning neural network. The reputation score is generated based on a combination of the results associated with each malicious behavior type from the neural network.

In an example, P₁ may have a value of 0.61 and represent the probability that the source autonomous vehicle may engage in a first malicious behavior type. P₂ may have a value of 0.23 and represent the probability that the source autonomous vehicle may engage in a second malicious behavior type. P₃ may have a value of 0 and represent the probability that the source autonomous vehicle may engage in a third malicious behavior type. The reputation score associated with the source autonomous vehicle may be calculated as (1−0.61)*(1−0.23)*(1−0)=0.285. Since the reputation score associated with the source autonomous vehicle has a value of 0.285, the source autonomous vehicle is classified as a malicious vehicle.

In an embodiment, the reputation score management module 308 determines the reputation score based on block chain technology. If an autonomous vehicle 100 joins a block chain and is trusted by the mechanism of the block chain, the autonomous vehicle 100 is classified as an honest vehicle. The reputation score generation module 208 is configured to generate a unique report identifier for each received vehicle behavior report and record the classification results on the block chain for evidence. A local block chain is generated within the scope of the local authority 200 to maintain a dynamic autonomous vehicle list and keep track of all the autonomous vehicles running within a pre-defined area. Introducing a global block chain may reduce the chances of a mass attack within a local blockchain. A global block chain is distributed over multiple edge computing systems and synchronized periodically to ensure consistency across the multiple edge computing systems.

In addition to enrollment and pseudo certification for each autonomous vehicle 100, the local authority 200 is configured to issue a digital signature that is kept in block chain. The digital signature is not dependent on a third-party authentication system. The block chain attempts to ensure that vehicle behavior reports are sent from trusted entities and may be leveraged directly to calculate the reputation score, where the reputation score is equal to blockchain awards

At 312, the reputation score generation module 208 stores the reputation score, the source vehicle data, the pseudo identifier in association with the permanent identifier associated with the source autonomous vehicle in the reputation score database 312

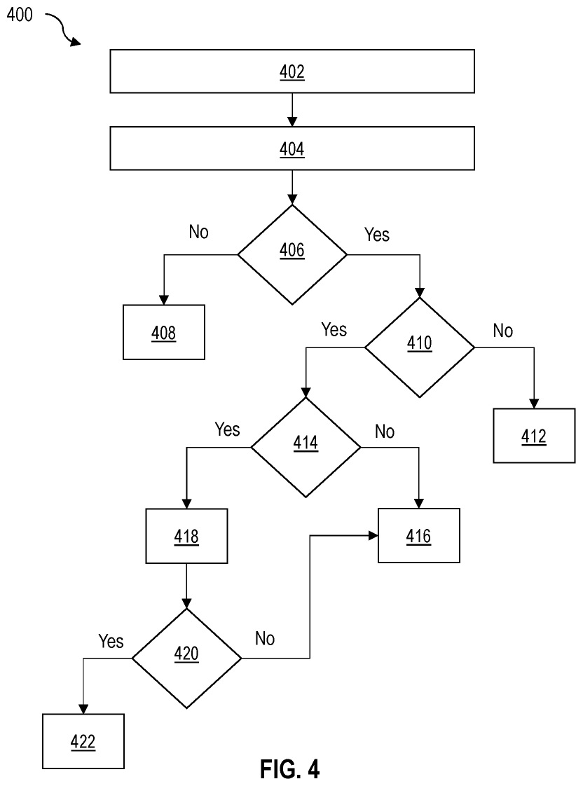

Referring to FIG. 4, a flow chart representation of an embodiment of a method 400 of detecting misbehavior at the ADS of an autonomous vehicle 100 is shown. The method 400 is performed by a controller 134 including an embodiment of a misbehavior detection system 110. The method 400 may be performed by the controller 134 in combination with other components of the autonomous vehicle 100. The method 400 may be performed by hardware circuitry, firmware, software, and/or combinations thereof.

At 402, a V2V message is received at the misbehavior detection system 110 of an ego autonomous vehicle 100_{EV}. The V2V message includes a pseudo identifier associated with a source autonomous vehicle and source vehicle data. The source autonomous vehicle may an honest vehicle engaging in legitimate vehicle behavior or a malicious vehicle. A malicious vehicle an actual autonomous vehicle engaging in malicious behavior, or a malicious entity posting as an actual autonomous vehicle. The source vehicle data includes source vehicle attributes associated with the source autonomous vehicle. Examples of the source vehicle attributes include, but are not limited to, a source vehicle speed, a source vehicle location, a source vehicle acceleration, and a source vehicle heading. In an embodiment, the V2V message is a BSM message.

At 404, the misbehavior detection system 110 identifies a sensor detection area associated with a vehicle sensor system 128 of the ego autonomous vehicle 100_{EV} at approximately the time that the V2V message is received at the ego autonomous vehicle 100_{EV}. At 406, the misbehavior detection system 110 determines whether the source vehicle location in the V2V message falls outside the sensor detection area of the vehicle sensor system 128. If the misbehavior detection system 110 determines that the source vehicle location falls within the sensor detection area, the misbehavior detection system 110 is configured to implement actions locally at the ego autonomous vehicle 100_{EV} to determine whether the received V2V message is a honest V2V message received from an honest vehicle or a malicious V2V message received from a malicious vehicle at 408.

If the misbehavior detection system 110 determines that the source vehicle location in the V2V message falls outside the sensor detection area, the misbehavior detection system 110 determines whether the vehicle sensing devices 140a-140n in the vehicle sensor system 128 used to determine the sensor detection area are operational at 410. If the misbehavior detection system 110 determines that the vehicle sensing devices 140a-140n used to determine the sensor detection area are not operational, a sensor repair indication is generated at 412.

If the misbehavior detection system 110 determines that the vehicle sensing devices 140a-140n used to determine the sensor detection area are operational, the misbehavior detection system 110 determines whether the received V2V message passes the vehicle plausibility check based on the source vehicle data in the V2V message at 414. The vehicle plausibility check is used to determine whether the source vehicle data in the V2V message is plausible. In an embodiment, the vehicle plausibility check includes one or more of a source vehicle speed plausibility check, a source vehicle position plausibility check, a source vehicle acceleration plausibility check, a source vehicle sudden appearance plausibility check, a vehicle message frequency plausibility check, a source vehicle heading plausibility check, and a vehicle successive message consistency plausibility check.

If the misbehavior detection system 110 determines that the source vehicle data has not passed the vehicle plausibility check, the misbehavior detection system 110 identifies the V2V message as a malicious V2V message and the source autonomous vehicle associated with the malicious V2V message as a malicious vehicle and transmits a vehicle behavior report associated with the pseudo identifier to the location authority 200 at the edge computing system 150 for processing by reputation score management system 152 at 416. The vehicle behavior report includes the unique vehicle identifier and a classification result. In an embodiment, the unique vehicle identifier includes the pseudo identifier. In an embodiment, the vehicle behavior report includes the pseudo identifier and one or more of a vehicle license plate of the source autonomous vehicle and at least one vehicle feature of the source autonomous vehicle. The classification result classifies the source autonomous vehicle as a malicious vehicle. In an embodiment, the vehicle behavior report includes a malicious behavior type associated with a classification of the source autonomous vehicle as a malicious vehicle. Examples of malicious behavior type include, but are not limited to, an improper source vehicle speed, an improper source vehicle location, and an improper vehicle acceleration. In an embodiment, the vehicle behavior report includes the source vehicle data. In an embodiment, the vehicle behavior report includes source vehicle features and/or historical source vehicle route data.

The misbehavior detection system 110 is configured to inform the ADS of the ego autonomous vehicle 100_{EV} that the received V2V message is a malicious V2V message and to disregard the source vehicle data associated with the malicious V2V message thereby ensuring that the ADS does not implement navigation and/or guidance actions based on the malicious source vehicle data in the malicious V2V message.

If the misbehavior detection system 110 determines that the source vehicle data has passed the vehicle plausibility check the misbehavior detection system 110 issues a reputation score request for a reputation score associated with the pseudo identifier to the reputation score management system 152 at the edge computing system 150 at 418. The reputation score request module 210 at the reputation score management system 152 receives the reputation score request including the pseudo identifier from the ego autonomous vehicle 100_{EV}. The reputation score request module 210 retrieves the reputation score associated with the received pseudo identifier from the reputation score database 212 and transmits the retrieved reputation score to the ego autonomous vehicle 100_{EV}.

The misbehavior detection system 110 determined whether the received reputation score is higher than a reputation score threshold at 420. If the misbehavior detection system 110 determines that the reputation score is higher than a reputation score threshold, the misbehavior detection system 110 identifies the received V2V message as an honest V2V message and a classification result identifying the source autonomous vehicle as an honest vehicle. The misbehavior detection system 110 transmits a vehicle behavior report associated with the pseudo identifier of the source autonomous vehicle to the local authority 200 at 422. For example, the reputation score may have a value ranging from zero to one. An example of a reputation score threshold may be 0.5. If the received reputation score is greater than the reputation score threshold 0.5, the source autonomous vehicle is considered an honest vehicle and the V2V message is considered an honest V2V message.

The vehicle behavior report includes the unique vehicle identifier and the classification result. In an embodiment the unique vehicle identifier is the pseudo identifier. In an embodiment, the unique vehicle identifier includes the pseudo identifier and one or more of a vehicle license plate of the source autonomous vehicle and at least one vehicle feature of the source autonomous vehicle. The classification result classifies the source autonomous vehicle as an honest vehicle. The misbehavior detection system 110 informs the ADS of the ego autonomous vehicle 100_{EV} that the received V2V message is an honest V2V message. The ADS implements navigation and/or guidance actions based on the honest source vehicle data in the honest V2V message.

In an embodiment, the ADS of the ego autonomous vehicle 100_{EV} is configured to analyze the source vehicle data to determine whether to there is a potential risk to the ego autonomous vehicle 100_{EV}. The ADS uses the identified potential risk to implement one or more risk avoidance actions. For example, source vehicle data associated with a source autonomous vehicle 100 may indicate that the source autonomous vehicle 100 is located at an intersection. The ADS of the ego autonomous vehicle 100_{EV} may determine that the source autonomous vehicle 100 poses a potential collision risk to ego autonomous vehicle 100_{EV}. The ADS may implement one or more actions to slow down or stop the ego autonomous vehicle 100_{EV} to avoid a potential collision with the source autonomous vehicle by issuing commands to the brake system 126.

If the misbehavior detection system 110 determines that the reputation score associated with the pseudo identifier of the source autonomous vehicle is lower than the reputation score threshold the misbehavior detection system 110 identifies the V2V message as a malicious V2V message and transmits a vehicle behavior report associated with the pseudo identifier to the location authority 200 at the edge computing system 150 for processing by the reputation score management system 152 at 416. The vehicle behavior report includes the unique vehicle identifier and a classification result. In an embodiment, the unique vehicle identifier includes the pseudo identifier. In an embodiment, the vehicle behavior report includes the pseudo identifier and one or more of a vehicle license plate of the source autonomous vehicle and at least one vehicle feature of the source autonomous vehicle. The classification result classifies the source autonomous vehicle as a malicious vehicle. In an embodiment, the vehicle behavior report includes the source vehicle data. In an embodiment, the vehicle behavior report includes a malicious behavior type associated with a classification of the source autonomous vehicle as a malicious vehicle. Examples of malicious behavior type include, but are not limited to, an improper source vehicle speed, an improper source vehicle location, and an improper vehicle acceleration. In an embodiment, the vehicle behavior report includes source vehicle features and/or historical source vehicle route data.

The misbehavior detection system 110 is configured to inform the ADS of the ego autonomous vehicle 100_{EV} that the received V2V message is a malicious V2V message and to disregard the source vehicle data associated with the malicious V2V message thereby ensuring that the ADS does not implement navigation and/or guidance actions based on the malicious source vehicle data in the malicious V2V message.

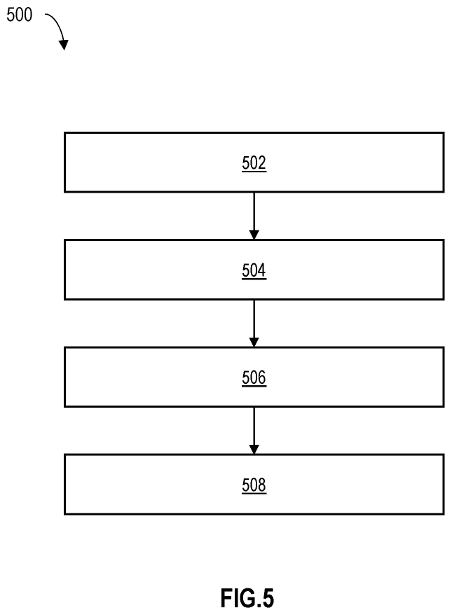

Referring to FIG. 5, a flow chart representation of an embodiment of a method 500 of managing reputation scores using an embodiment of the reputation score management system 152 is shown. The method 500 may be performed by hardware circuitry, firmware, software, and/or combinations thereof.

At 502, at least two vehicle behavior reports associated with a source autonomous vehicle are received at a reputation score management system 152, each of the at least two vehicle behavior reports being received from a corresponding one of at least two traffic autonomous vehicles 100_{TV1}, 100_{TV2}, 100_{TVN} and comprising a unique vehicle identifier and a classification result associated with the source autonomous vehicle. At 504, a reputation score is generated for association with the unique vehicle identifier based at least in part on the classification results received in the at least two vehicle behavior reports at the reputation score management system 152. At 506, a request for the reputation score associated with the unique vehicle identifier is received from an ego autonomous vehicle 100_{EV} at the reputation score management system 152. At 508, the requested reputation score is transmitted from at the reputation score management system 152 to the ego autonomous vehicle 100_{EV} to enable the ego autonomous vehicle 100_{EV} to determine whether a vehicle-to-vehicle (V2V) message including the unique vehicle identifier associated with the requested reputation score is one of an honest V2V message and a malicious V2V message based in part on the reputation score.

The reputation score management system 152 maintains updated reputation scores associated with different autonomous vehicles 100. The use of reputation scores to assist misbehavior detection systems 110 at autonomous vehicles 100 to determine whether a source autonomous vehicle associated with a received V2V messages is either malicious vehicle or an honest vehicle may facilitate the identification of sybil attacks by malicious vehicles or by ghost vehicles. The identification the source vehicles associated with a received V2V messages as malicious vehicles may reduce the incorporation of malicious source vehicle data received via malicious V2V messages into the Intelligent Transportation System (ITS) of autonomous vehicles 100. The use of misbehavior detection systems 110 at autonomous vehicles 100 may assist with the removal of misbehaving or malicious entities from the V2X ecosystem thereby protecting the autonomous vehicles 100 as well as the overall the autonomous vehicle system.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It is to be understood that various changes can be made in the function and arrangement of elements without departing from the scope of the disclosure as set forth in the appended claims and the legal equivalents thereof.

What is claimed is:

1. A reputation score management system at an edge computing system, comprising:
a processor; and
a memory, the memory comprising instructions that upon execution by the processor, cause the processor to:
receive at least two vehicle behavior reports associated with a source autonomous vehicle, each of the at least two vehicle behavior reports being received from a corresponding one of at least two traffic autonomous vehicles and comprising a unique vehicle identifier and a classification result associated with the source autonomous vehicle;
generate a reputation score for association with the unique vehicle identifier based at least in part on the classification results received in the at least two vehicle behavior reports;
receive a request for the reputation score associated with the unique vehicle identifier from an ego autonomous vehicle; and
transmit the requested reputation score to the ego autonomous vehicle to enable the ego autonomous vehicle to determine whether a vehicle-to-vehicle (V2V) message including the unique vehicle identifier associated with the requested reputation score is one of an honest V2V message and a malicious V2V message based in part on the reputation score.

2. The system of claim 1, wherein the memory further comprises instructions that upon execution by the processor, cause the processor to generate the reputation score based on an application of a classification result algorithm to the classification results received in the at least two vehicle behavior reports.

3. The system of claim 1, wherein a first vehicle behavior report includes a first detection result in connection with a first malicious behavior type associated with a first weight and a second vehicle behavior report includes a second detection result in connection with a second malicious behavior type associated with a second weight and the memory further comprises instructions that upon execution by the processor, cause the processor to generate the reputation score based on an application of a weighted malicious behavior algorithm to the first detection result in accordance with the first weight and the second detection result in accordance with the second weight.

4. The system of claim 1, wherein the at least two vehicle behavior reports in aggregate comprises a first combination of different forms of a first malicious behavior type and a second combination of different forms of a second malicious behavior type and the memory further comprises instructions that upon execution by the processor, cause the processor to generate the reputation score based on an application of a Dempster-Shafer algorithm to the first combination of different forms of the first malicious behavior type and the second combination of different forms of a second malicious behavior type and a belief function value associated with each of the at least two traffic autonomous vehicles.

5. The system of claim 1, wherein the memory further comprises instructions that upon execution by the processor, cause the processor to generate the reputation score based on an application of a machine learning algorithm to a plurality of probabilities associated with the source autonomous vehicle and a probability of generation of a reputation score classifying the source autonomous vehicle as a malicious vehicle, each of the plurality of probabilities being associated with a probability that the source autonomous vehicle will engage in a misbehavior type.

6. The system of claim 1, wherein the memory further comprises instructions that upon execution by the processor, cause the processor to:
generate a unique report identifier for each of the at least two vehicle behavior reports received from the corresponding one of the at least two traffic autonomous vehicles, each of the at least two traffic autonomous vehicles being classified as an honest vehicle based on an association with a block chain; and
record the classification results received in each of the at least two vehicle behavior reports at the block chain.

7. The system of claim 1, wherein the memory further comprises instructions that upon execution by the processor, cause the processor to receive a vehicle behavior report from the ego autonomous vehicle, the vehicle behavior report including a classification result classifying the source autonomous vehicle as one of a honest vehicle and a malicious vehicle based in part on the reputation score associated with the source autonomous vehicle.

8. A computer readable medium comprising instructions stored thereon for managing reputation scores, that upon execution by a processor, cause the processor to:
receive at least two vehicle behavior reports associated with a source autonomous vehicle, each of the at least two vehicle behavior reports being received from a corresponding one of at least two traffic autonomous vehicles and comprising a unique vehicle identifier and a classification result associated with the source autonomous vehicle;
generate a reputation score for association with the unique vehicle identifier based at least in part on the classification results received in the at least two vehicle behavior reports;
receive a request for the reputation score associated with the unique vehicle identifier from an ego autonomous vehicle; and
transmit the requested reputation score to the ego autonomous vehicle to enable the ego autonomous vehicle to determine whether a vehicle-to-vehicle (V2V) message including the unique vehicle identifier associated with the requested reputation score is one of an honest V2V message and a malicious V2V message based in part on the reputation score.

9. The computer readable medium of claim 8, further comprising instructions to cause the processor to generate the reputation score based on an application of a classification result algorithm to the classification results received in the at least two vehicle behavior reports.

10. The computer readable medium of claim 8, further comprising instructions to cause the processor to generate the reputation score based on an application of a weighted malicious behavior algorithm to a first detection result in accordance with a first weight and a second detection result in accordance with a second weight, wherein a first vehicle behavior report includes the first detection result in connection with a first malicious behavior type associated with the first weight and a second vehicle behavior report includes the second detection result in connection with a second malicious behavior type associated with the second weight.

11. The computer readable medium of claim 8, further comprising instructions to cause the processor to generate the reputation score based on an application of a Dempster-Shafer algorithm to a first combination of different forms of a first malicious behavior type and a second combination of different forms of a second malicious behavior type and a belief function value associated with each of the at least two traffic autonomous vehicles, wherein the at least two vehicle behavior reports in aggregate comprises the first combination of different forms of the first malicious behavior type and the second combination of different forms of the second malicious behavior type.

12. The computer readable medium of claim 8, further comprising instructions to cause the processor to generate the reputation score based on an application of a machine learning algorithm to a plurality of probabilities associated with the source autonomous vehicle and a probability of generation of a reputation score classifying the source autonomous vehicle as a malicious vehicle, each of the plurality of probabilities being associated with a probability that the source autonomous vehicle will engage in a misbehavior type.

13. The computer readable medium of claim 8, further comprising instructions to cause the processor to:
generate a unique report identifier for each of the at least two vehicle behavior reports received from the corresponding one of the at least two traffic autonomous vehicles, each of the at least two traffic autonomous vehicles being classified as an honest vehicle based on an association with a block chain; and
record the classification results received in each of the at least two vehicle behavior reports at the block chain.

14. The computer readable medium of claim 8, further comprising instructions to cause the processor to receive a vehicle behavior report from the ego autonomous vehicle, the vehicle behavior report including a classification result classifying the source autonomous vehicle as one of a honest vehicle and a malicious vehicle based in part on the reputation score associated with the source autonomous vehicle.

15. A method of managing reputation scores comprising:
receiving at least two vehicle behavior reports associated with a source autonomous vehicle at a reputation score management system, each of the at least two vehicle behavior reports being received from a corresponding one of at least two traffic autonomous vehicles and comprising a unique vehicle identifier and a classification result associated with the source autonomous vehicle;
generating a reputation score for association with the unique vehicle identifier based at least in part on the classification results received in the at least two vehicle behavior reports at the reputation score management system;
receiving a request for the reputation score associated with the unique vehicle identifier from an ego autonomous vehicle at the reputation score management system; and
transmitting the requested reputation score from at the reputation score management system to the ego autonomous vehicle to enable the ego autonomous vehicle to determine whether a vehicle-to-vehicle (V2V) message including the unique vehicle identifier associated with the requested reputation score is one of an honest V2V message and a malicious V2V message based in part on the reputation score.

16. The method of claim 15, further comprising generating the reputation score based on an application of a classification result algorithm to the classification results received in the at least two vehicle behavior reports at the reputation score management system.

17. The method of claim 15, further comprising generating the reputation score based on an application of a weighted malicious behavior algorithm to a first detection result in accordance with a first weight and a second detection result in accordance with a second weight at the reputation score management system, wherein a first vehicle behavior report includes the first detection result in connection with a first malicious behavior type associated with the first weight and a second vehicle behavior report includes the second detection result in connection with a second malicious behavior type associated with the second weight.

18. The method of claim 15, further comprising generating the reputation score based on an application of a Dempster-Shafer algorithm to a first combination of different forms of a first malicious behavior type and a second combination of different forms of a second malicious behavior type and a belief function value associated with each of the at least two traffic autonomous vehicles at the reputation score management system, wherein the at least two vehicle behavior reports in aggregate comprises the first combination of different forms of the first malicious behavior type and the second combination of different forms of the second malicious behavior type.

19. The method of claim 15, further comprising generating the reputation score based on an application of a machine learning algorithm to a plurality of probabilities associated with the source autonomous vehicle and a probability of generation of a reputation score classifying the source autonomous vehicle as a malicious vehicle at the reputation score management system, each of the plurality of probabilities being associated with a probability that the source autonomous vehicle will engage in a misbehavior type.

20. The method of claim 15, further comprising:
generating a unique report identifier for each of the at least two vehicle behavior reports received from the corresponding one of the at least two traffic autonomous vehicles, each of the at least two traffic autonomous vehicles being classified as an honest vehicle based on an association with a block chain; and
recording the classification results received in each of the at least two vehicle behavior reports at the block chain.
